(19) United States
(12) Patent Application Publication
(10) Pub. No.: US 2011/0155524 A1
(43) Pub. Date: Jun. 30, 2011

(54) DEVICE FOR COMPENSATING FOR THE VOLUME OF THE BODY OF A HYDRAULIC SUSPENSION SHOCK-ABSORBING DEVICE

(76) Inventor: Dominique Crasset, La Cour Marigny (FR)

(21) Appl. No.: 13/058,664

(22) PCT Filed: Jul. 24, 2009
(86) PCT No.: PCT/FR09/00924

§ 371 Date: Mar. 21, 2011

(30) Foreign Application Priority Data
Aug. 14, 2008 (FR) 0804591

(51) Int. Cl. B60G 13/08; F16F 9/26; F16F 9/22; B60G 15/06

(52) U.S. Cl. 188/316; 267/217

(57) ABSTRACT

A compensation device for a shock absorber comprising a hydraulic volume formed by two chambers separated by a removable wall of a piston and including at least one cartridge defining a shock-absorber body and a rod attached to the mobile wall of the piston. The hydraulic shock absorber includes an outer tube defining a cartridge in which said shock body is provided. The inner wall of the outer tube being capable of sliding against the outer wall of the shock absorber body so as to compensate, at the hydraulic chamber in which the piston rod is inserted, for the volume of the portion of the piston rod inserted into the hydraulic chamber upon a compression phase.

This invention relates to the field of suspension shock-absorbing devices and, more specifically, to the field of devices enabling compensation for the volume of suspension shock-absorbing device body on land vehicles.

A shock-absorbing device is composed of several elements including, among others, a rod fitted with a mobile wall at one of its ends, sliding inside the shock-absorbing device body; the second end of the rod and the shock-absorbing device body being attached to two parts which may move between one to another and to be dampened by the shock-absorbing device. The rod of the shock-absorbing device is attached to an external tube sliding together with the mobile wall while surrounding the shock-absorbing device body.

The shock-absorbing device body forms with, at least, one section of the external tube, a separate reservoir which is divided into two volumes by the shock-absorbing device mobile wall and filled with hydraulic fluid. Insertion of the shock-absorbing device rod into the shock-absorbing device body leads to an increase in the pressure applied onto the fluid circulating inside the shock-absorbing device; a section of the shock-absorbing device rod occupying the reservoir space created by the shock-absorbing device body and the external tube. Gaseous fluid is capable of easily withstanding compression when the reservoir volume is reduced when the shock-absorbing device rods is inserted into the reservoir. However, when the fluid is a liquid, such as oil, the compression ratio is limited and restricting insertion of the rod into the reservoir and maximum displacement of the mobile wall until the shock-absorbing device is blocked; which reduces sliding capacity and therefore dampening capacity of the device. The volume of the shock-absorbing device body must then be compensated for by a volume equivalent to the volume of the rod inserted into the body.

To cope with this fluid compression problem relating to a shock-absorbing device and caused by the fact that the rod is inserted into the shock-absorbing device oil reservoir, there are presently several solutions.

The first solution consists in using a volume of compressible gas on which is supported the oil volume. Each time the rod is inserted into the oil volume, compensation is ensured by elasticity of gas and the oil volume transmitting the pressure exerted when the rod is inserted into the volume of oil.

The advantage of this solution is to keep oil under pressure on a permanent basis; which delays emulsion phenomena that may occur. However, the disadvantage of such a solution is that it is cumbersome and expensive since it requires tight separation between oil and gas volumes and nitrogen inflation; the column of oil must also be positioned downstream from the piston permanently.

The second solution consists in using a twin-tube shock-absorbing device. In this type of shock-absorbing device, a tube is partly filled with gas and oil and surrounds the shock-absorbing device. Annular volume is thus available between the outside of the shock-absorbing device and the inside of the tube which is used as a second reservoir receiving the oil volume rejected outwards the shock-absorbing device. The oil rejected into this second reservoir also uses elasticity of gas located in the annular volume to enable compensation for the rod volume progressively occupying a part of the oil reservoir volume inside the shock-absorbing device. Back and forth movements of oil between the shock-absorbing device reservoir and the second reservoir formed by the annular volume are controlled by valves. However, the disadvantage of such a dampening device is that it is cumbersome and must be kept in a slightly vertical position without having to keep the oil in the shock-absorbing device under pressure; which may cause cavitation phenomena.

The purpose of this invention is to compensate for one or several disadvantages developed by the prior art and, in particular, to offer a new shock-absorbing device enabling to compensate for the volume occupied by the rod when it is inserted into the oil volume inside the shock-absorbing device body while making positioning without axial limitation possible with minimum bulkiness and limited manufacturing costs in comparison with the other devices developed by the prior art.

This objective is obtained through this compensation device for a hydraulic suspension shock-absorbing device to be fitted between, at least, two parts of a vehicle and mounted in such a way that mobility between both parts is kept and/or both parts are connected to a spring element fitted together with the shock-absorbing device; the hydraulic shock-absorbing device including:
A volume specific to one of the two parts of the vehicle and integrating a hydraulic part formed by two chambers separated by the piston mobile wall in which there is at least one orifice for passage of fluid from one chamber to another chamber; hydraulic part volume being created, at least, by a cartridge used as shock-absorbing device body,
A piston rod with one end attached to the piston mobile wall and with the other end attached to the second part of the vehicle, the piston rod being aligned parallel to the shock-absorbing device body axis,
   characterised in that the hydraulic shock-absorbing device is composed of an external tube creating a cartridge in which the shock-absorbing device body is arranged, the inner wall of the external tube being likely to slide against the outer wall of the shock-absorbing device to compensate for, inside the hydraulic chamber into which the piston rod is inserted, the volume of the section of the piston rod being inserted into the hydraulic chamber during compression.

According to another variant embodiment, the compensation device for a hydraulic suspension shock-absorbing device is characterised in that sliding of the external tube inner wall and the shock-absorbing device body outer wall is obtained through sliding of the external tube towards the shock-absorbing device body in order to create a tight annular space adjoining the chamber of the shock-absorbing device hydraulic part into which the piston rod is inserted during compression of the shock-absorbing device; the annular space being used for receiving, partly, a quantity of fluid displaced by the volume occupied by the piston rod in the hydraulic chamber during compression, and in that the annular space adjoins the hydraulic part of the shock-absorbing device body at the level of, at least, one orifice located in the shock-absorbing device body section positioned on the side of the hydraulic chamber occupied by the piston rod.

According to another variant embodiment, the compensation device for the hydraulic suspension shock-absorbing device is characterised in that, in a plane perpendicular to the axis of the piston and/or of the external tube, the section of the piston rod and the section of the annular space between the external tube and the shock-absorbing device body have similar surfaces; in this way, the space occupied by the piston rod part inserted into the hydraulic chamber is similar to the increase of the volume formed by the annular space between the external tube and the shock-absorbing device body.

According to another variant embodiment, the compensation device for the hydraulic suspension shock-absorbing device is characterised in that the shock-absorbing device being an oleopneumatic shock-absorbing device, a tight wall through which goes the piston rod closing the volume of the hydraulic part at the end of the shock-absorbing device body cartridge, the piston rod is mounted fixed together with the external tube in such a way that both the piston rod and the external tube are interdependent during sliding relative to the shock-absorbing device body and enable coordination between insertion of the piston rod into the hydraulic chamber and creation of a suitable volume by the annular space existing between the external tube and the shock-absorbing device body.

According to another variant embodiment, the compensation device for the hydraulic suspension shock-absorbing device is characterised in that the part of the external tube that is not opposite to the shock-absorbing device body is formed by a cartridge creating a tight volume and in which gas is kept compressed between one end of the cartridge and the surface of the shock-absorbing device body in which the piston rod is inserted and which includes a wall kept tight, between the gas volume and the liquid volume, via a first seal located between the wall and the rod and via a second seal located between the wall outline and the inside edge of the external tube; the volume of compressed gas enabling the liquid in the hydraulic part of the shock-absorbing device to be kept under pressure through the tight wall, transmitting gas pressure to the liquid in the hydraulic part via the seals used for keeping the separating wall sealed between gas and liquid.

According to another variant embodiment, the compensation device for the hydraulic shock-absorbing device is characterised in that, the annular space being sealed with one or several seals located between the inner wall of the external tube and the outer wall of the shock-absorbing device body; at least one seal may be subject to deformation or displacement relative to the structure on which it has been fixed to compensate for variation in the annular space volume.

According to another variant embodiment, the compensation device for the hydraulic suspension shock-absorbing device is characterised in that the shock-absorbing device being coupled with a spring, the first end of which is supported against the part of the vehicle to which is fixed the piston rod; the external tube sliding tightly with the shock-absorbing device body cartridge also creates a cartridge closing the hydraulic part of the shock-absorbing device when the piston rod goes through it, the external tube being composed of, at least, a fastening device against which the other end of the spring is supported to exert pressure on the external tube in order to keep the fluid inside the hydraulic cavity under pressure.

According to this other variant embodiment, the compensation device for the hydraulic suspension shock-absorbing device is characterised in that insertion of the piston rod into the hydraulic chamber causes sliding by pushing the shock-absorbing device body cartridge and the external tube cartridge aside, which increases total volume of the hydraulic part of the shock-absorbing device, this increase in volume being proportional to the volume of the piston rod section inserted into the chamber.

The other purpose of this invention is to offer an operating process for the compensation device.

This objective is obtained using an operating process developed for a compensation device designed for a hydraulic suspension shock-absorbing device, which includes at least:
A compression step of which the shock-absorbing device with, at least, one section of the piston rod being inserted into one of the chambers of the hydraulic part of the shock-absorbing device,
   characterised in that this process includes a compensation phase through:
a step during which the shock-absorbing device body slides relative to the external tube to adapt the annular space to insertion of the piston rod into one of the hydraulic chambers.

According to a variant embodiment of the invention, the working process for a compensation device designed for a hydraulic suspension shock-absorbing device is characterised in that the process is composed of, at least, one step during which the liquid in the hydraulic part of the shock-absorbing device is kept under pressure; which is made possible through:
a pressure step created by compressed gas through a tight wall separating the liquid and the gas volume compressed in the shock-absorbing device, compensating for the pressure exerted by the liquid in the hydraulic part against the tight wall, or
a pressure step created by a spring compressing the external tube to reduce the total volume of the hydraulic part into which a section of the piston rod is inserted.

The invention, with its characteristics and advantages, will emerge more clearly from the following description given in reference to the attached diagrams, in which:

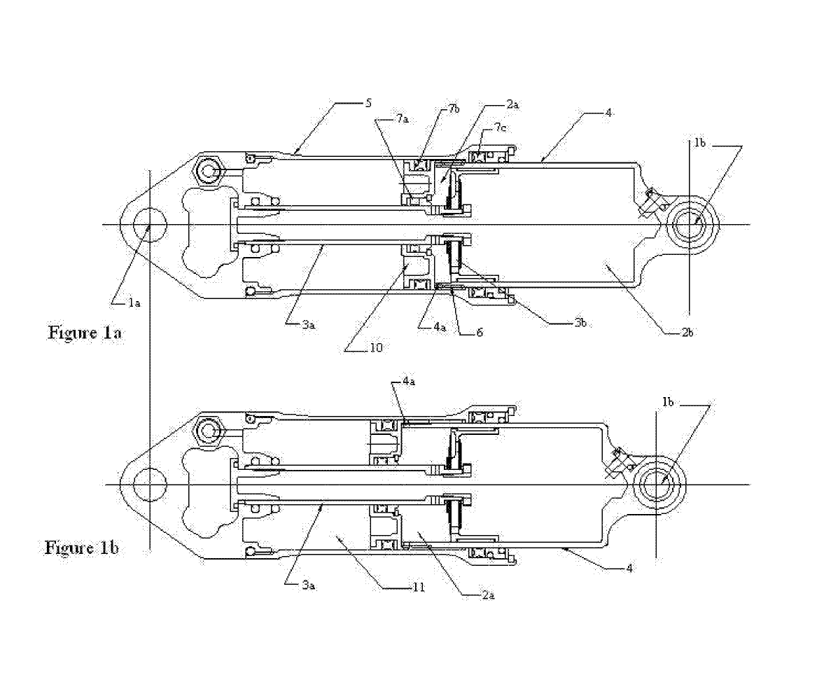

FIG. 1a schematically illustrates an example of lateral section of a first variant of the compensation device for a suspension shock-absorbing device when the shock-absorbing device is extended,

FIG. 1b schematically illustrates an example of lateral section of the first variant of the compensation device for a suspension shock-absorbing device when the shock-absorbing device is compressed,

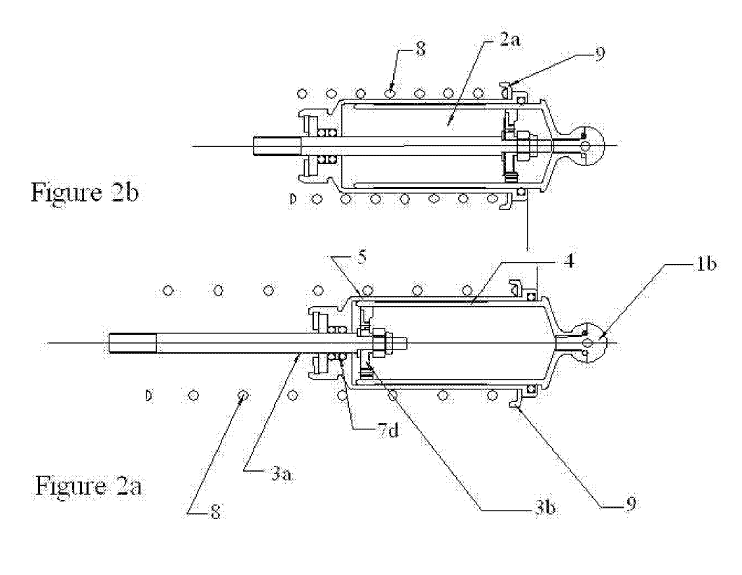

FIG. 2a schematically illustrates an example of lateral section of a second variant of the compensation device for a suspension shock-absorbing device when the shock-absorbing device is extended,

FIG. 2b schematically illustrates an example of lateral section of a second variant of the compensation device for a suspension shock-absorbing device when the shock-absorbing device is compressed,

The device of the invention relates to a compensation device designed so as to be integrated into a suspension shock-absorbing device mounted between two mobile parts on a vehicle. The purpose of this device is to solve the problem relating to incompressibility of the liquid in the hydraulic shock-absorbing device when the volume of the rod (3a) of the shock-absorbing device piston inserted into the hydraulic part (2a, 2b) increases while the shock-absorbing device is being compressed.

According to the first variant embodiment, the shock-absorbing device is of oleopneumatic type. The shock-absorbing device is composed of a hydraulic part (2a, 2b) which forms a reservoir for hydraulic fluid, such as oil or any other well-known type of fluids used in hydraulic shock-absorbing devices. The hydraulic fluid reservoir (2a, 2b) is formed by a cartridge created by the shock-absorbing device body (4). The orifice in this cartridge is plugged by a wall (10), through which goes the rod (3a) of the piston. The orifice (10a) for passage of the rod (3a) which goes through the wall (10) includes a seal (7a) enabling sealing by ensuring that the rod (3a) and the wall (10) of the hydraulic fluid reservoir are joined. The external end (1b) of the shock-absorbing device body cartridge (4) is fixed to one of the mobile parts on the vehicle on which the shock-absorbing device is fitted. The shock-absorbing device body (4) is inserted into a piece forming an external tube (5). Positioning is performed in such a way that the outer wall of the radial surface of the shock-absorbing device (4) is fixed while sliding with the inner wall of the external tube (5). The shock-absorbing device body (4) and the external tube (5) are both assembled coaxially; in this way, they can slide along an axis, one with respect to the other. Both elements (4, 5) have thus cross sections of similar shape, preferably circular, even if other shapes can be used when making the invention. The hydraulic fluid reservoir (2a, 2b) is divided into two chambers (2a, 2b), separated from one another, by a mobile wall (3b) assembled to one end of the shock-absorbing device piston rod (3a). The other end (1a) of the rod (3a), outside the hydraulic part, is assembled to the second mobile part on the vehicle on which the shock-absorbing device operates.

The chamber (2a) of the hydraulic fluid reservoir (2a, 2b) in which the shock-absorbing device piston rod (3a) is arranged adjoins the annular volume (6) located between the outer wall of the radial surface of the shock-absorbing device body (4) and the inner surface of the external tube (5). The inner diameter of the external tube (5) is thus slightly greater than the outer diameter of the shock-absorbing device body (4); in this way annular space is formed over the length of those two elements (4,5), located opposite to one another. Connection between this annular space (6) and the chamber (2a) of the hydraulic fluid reservoir is performed at the level of one or several orifices (4a) located on the outline of the shock-absorbing device end (4) near the stopping wall (10). These orifices (4a) may have the shape of bores, for example, going through the thickness of the shock-absorbing device body (4), or even the shape of a recess in the thickness and on the outer wall of the shock-absorbing device body (4). Sealing of the annular space (6) is ensured by, on the one hand, a first seal (7c) used for sealing between the inner surface of the external tube (5) and the outer surface of the shock-absorbing device body (4) at the level of the end of the annular volume (6), located on the side of the attachment of the shock-absorbing device body (4) on the vehicle; and on the other hand, by a second seal (7b) used for sealing between the external edge of the tight wall (10) creating the end of the shock-absorbing device body (4) and the inner surface of the external tube (5). The first seal (7c) is mounted inside the end of the inner wall of the external tube (5) and ensures sealing by sliding against the inner wall of the shock-absorbing device body (4). The second seal (7b) is mounted at the end of the shock absorbing device body (4) located on the edge of the chamber (2a) of the reservoir which comprises the rod (3a) of the piston. This second seal (7b) can be directly assembled to the end of the shock-absorbing-device body (4) or even to the radial edge of the wall (10) stopping the shock-absorbing device body cartridge (4) to form the hydraulic fluid reservoir (2a, 2b). This second seal (7b) thus slides against the inner surface of the external tube (5). The seals (7b, 7c) are kept in position during friction when sliding, using anti-extrusion devices for keeping the seals (7b, 7c) in position.

The annular volume (6) varies according to the length of the radial surfaces of the shock-absorbing device body (4) and the external tube (5) which are opposite and thus according to sliding of the shock-absorbing device body (4) relative to the external tube (5) and the distance between the seals (7b,7c) used for keeping the annular space (6) sealed. The external tube (5) is assembled so as to be interdependent with the rod (3a) of the piston when sliding in the shock-absorbing device; in this way, both the mobile wall (3b) and the external tube (5) move at the same time. Sliding interdependence enables, when the shock-absorbing device is compressed by the rod (3a) inserted into the chamber (2a) of the reservoir, an increase in the annular volume (6). The volume of the hydraulic fluid reservoir (2a, 2b) occupied by the rod body (3a) is then compensated for by the annular volume (6) that increases the total volume of the hydraulic fluid reservoir (2a, 2b). The hydraulic fluid is partly displaced from the chamber (2a) receiving the piston rod (3a) towards the annular space (6) between the external tube (5) and the shock-absorbing device body (4).

According to a particular embodiment, in a section perpendicular to the piston rod (3a) axis, the surface of the annular space (6) is similar to the surface of the rod (3a). Similarity between the section surfaces allows to obtain a perfect compensation for the volume occupied by the part of the rod (3a) that is inserted into the hydraulic chamber (2a) of the reservoir (2a, 2b). The compensation stroke of the external tube (5) for obtaining the annular volume (6) is thus strictly similar to the volume of the rod (3a) which is added to the total volume of the hydraulic fluid reservoir (2a,2b).

According to a variant embodiment, the seals (7b, 7c) which ensure sealing of the annular space (6) are deformable, such as, hollow O-ring seals. These seals (7b, 7c) can also be assembled so as to be mobile relative to the structure on which they are respectively fixed. This mobility is illustrated by seal displacement relative to the structure against which it is supported; this displacement being a movement added to the sliding of the seal against the surface of the structure opposite to which it is positioned. This particular mobility of seals (7b, 7c) enables the annular volume (6) added to sliding of the external tube (5) to be adapted with respect to the shock-absorbing device body (4). The volume needs to be adapted notably when the section of the piston rod (3a) has a surface different from the surface of the section of the annular space (6). It can also be needed to compensate for possible expansion of the shock-absorbing device fluid caused by overheating.

According to another particular variant embodiment, the external tube (5) also forms a cartridge in which the piston rod (3a) is assembled. This cartridge (5) enables a volume (11) to be created and which is closed by the wall (10) fixed at the end of the shock-absorbing device body (4). On the one hand, this volume is kept sealed by the seal (7a) used for junction between the body of the piston rod (3a) and the wall (10) and on the other hand, by the seal (7b) positioned on the edge of the wall (10) against the inner surface of the external tube. This sealed volume (11) keeps the gas trapped in order to, on the one hand, enable spring return and, on the other hand, pressurization of the hydraulic fluid in the reservoir by exerting gas pressure on the fluid through the wall (10) fixed at the end of the shock-absorbing device body (4). When the shock-absorbing device is indeed subject to compression, the shock-absorbing device body (4) slides inside the external tube (5), in such a way that the piston rod (3a) simultaneously slides inside the hydraulic fluid reservoir (2a, 2b) of the shock-absorbing device body (4) to displace the mobile wall (3b) of the piston. This sliding movement causes simultaneously sliding of the wall (10) that closes the cartridge of the shock-absorbing device body (4) inside the external tube (5), compressing the gas trapped in the volume of the internal tube (5). Compressed gas transfers pressure through the seals (7a, 7b) on the wall (10) and allows the hydraulic fluid to be kept under pressure in the reservoir (2a, 2b) when the mobile wall (3b) of the piston is displaced, which leads to a decrease in fluid pressure in the chamber (2a) receiving the piston rod (3a). This pressure transfer, from gas to hydraulic fluid through the wall (10) allows to delay or even to avoid emulsion phenomena and/or cavitation phenomena in the hydraulic fluid. The external tube (5) is the same structure used for making the compressed gas reservoir (11), the hydraulic fluid reservoir (2a, 2b) and the annular volume (6) that is used for compensating for the volume of the piston rod (3a) inserted into one (2a) of the shock-absorbing device chambers.

According to a second embodiment, the shock-absorbing device is coupled with a spring (8) ensuring, among other functions, spring return in extension after a compression phase. In this second embodiment, the hydraulic fluid reservoir (2a, 2b) is made up of a first cartridge formed by the shock-absorbing device body (4); this cartridge is inserted into a second cartridge formed by the external tube (5). Both cartridges (4, 5) are inserted into one another, in such a way that the first cartridge can slide axially inside the second. This sliding movement allows a reservoir (2a, 2b) whereof the total volume may vary according to sliding of the shock-absorbing device body (4) relative to the external tube (5), while keeping a given length of their respective radial surfaces in opposite position.

As for the first embodiment, the shock-absorbing device body (4) and the external tube (5) may include a cylindrical section, or any other section that is adapted to axial sliding of the elements (4, 5) between one another. Moreover, the outer end of the shock-absorbing device body (4) is also attached to one of the mobile parts of the vehicle on which the shock-absorbing device is mounted. The other end of the shock-absorbing device is assembled to the second mobile part of the vehicle on which is mounted the end of the piston rod (3a).

The piston rod (3a) goes through the end of the cartridge of the external tube (5) and slides through it so as to displace the mobile wall (3b) of the piston inside the hydraulic fluid reservoir (2a, 2b). The external tube (5) and the rod (3a) are two parts that are not fastened between one another since the rod (3a) slides while going through the external tube (5). The junction between the rod (3a) and the end of the cartridge of the external tube (5) is performed by using a seal (7d) ensuring sealing of the cartridge. This mobile wall (3b) provides division of the shock-absorbing device reservoir (2a, 2b) into two chambers (2a, 2b). Sliding of the rod (3a) is performed along a parallel axis or an axis similar to the sliding axis of the external tube (5) relative to the shock-absorbing device body (4).

When the shock-absorbing device is subject to compression, the volume occupied by the rod (3a) being inserted into the hydraulic fluid reservoir (2a, 2b) is compensated for by sliding which pushes aside the external tube (5) of the shock-absorbing device body (4). This separation leads to an increase in the total volume of the hydraulic fluid reservoir (2a, 2b) and allows compensation for the volume of the part of the rod (3a) inserted into the chamber (2a). The compensation stroke of the external tube (5) is then performed by sliding in a direction opposite to the displacement direction of the piston rod (3a).

According to an embodiment preferred to the second embodiment of the invention, the outer surface of the radial wall of the external tube (5) includes one or several shoulders. One of the ends of the spring (8) coupled with the shock-absorbing device are supported by these shoulders (9). The second end of the spring (8) is supported against an element assembled to a second mobile part of the vehicle, for example the piston rod (3a), on which the shock-absorbing device is mounted. The spring (8) supported against a shoulder (9) exerts a return force on the external tube (5) and keeps the hydraulic fluid under pressure to prevent occurrence of any cavitation and emulsion phenomena in the shock-absorbing device fluid.

It must be evident for a person skilled in the art that the present invention allows embodiments in numerous other specific forms without departing from the field of application of the invention as claimed. Consequently, the present embodiments must be considered by way of illustration but can be modified in the field defined by the scope of the attached claims.

1. A compensation device for a hydraulic suspension shock-absorbing device designed to be mounted between at least two parts of a vehicle mounted mobile to each other and/or associated with a spring element mounted with the shock-absorbing device, the shock-absorbing device comprising:
a volume fixed to a first of the two parts of the vehicle and integrating a hydraulic part and formed by two chambers separated by a mobile wall of a piston having at least one orifice for passage of fluid from one chamber to another, the volume of the hydraulic part being composed of at least one cartridge forming the shock-absorbing device body,
a rod of the piston whereof a first end is fixed to the mobile wall of the piston and whereof the second end is fixed on the second of the two parts of the vehicle, the rod of the piston being aligned along the axis parallel to the axis of the shock-absorbing device body,
wherein the compensation device for the shock-absorbing device is fitted with an external tube forming a cartridge in which the shock-absorbing device body is arranged, the inner wall of the external tube being slideable against the outer wall of the shock-absorbing device body to compensate for, at the level of the hydraulic chamber into which the piston rod is inserted, the volume of the part of the piston rod inserted into the hydraulic chamber during compression.

2. The compensation device for a hydraulic suspension shock-absorbing device as claimed in claim 1, wherein the external tube is slideable, to perform sliding between the inner wall of the external tube and the outer wall of the shock-absorbing device body, towards the shock-absorbing device body to create an annular space connected to the chamber of the hydraulic part of the shock-absorbing device body into which the rod of the piston is inserted during compression of the shock-absorbing device, the annular space being configured to receive at least one part of the volume of the fluid displaced by the volume occupied by the rod of the piston in the hydraulic chamber during compression, and the annular space being connected to the hydraulic part of the shock-absorbing device body at the level of at least one orifice located in the part of the shock-absorbing device body positioned on the side of the hydraulic chamber occupied by the rod of the piston.

3. The compensation device for a hydraulic suspension shock-absorbing device as claimed in claim 2, wherein, in a plane perpendicular to the axis of the piston and/or the external tube, the section of the piston rod and the section of the annular space between the external tube and the body of the shock-absorbing device have similar surfaces so as to obtain that the volume occupied by the part of the rod of the piston inserted into the hydraulic chamber is identical to the increase in the volume created by the annular space between the external tube and the body of the shock-absorbing device.

4. The compensation device for a hydraulic suspension shock-absorbing device as claimed in claim 2, wherein, the shock-absorbing device being an oleopneumatic shock-absorbing device, a sealed wall through which extends the rod of the piston closing the volume of the hydraulic part at the end of the cartridge of the body of the shock-absorbing device, the rod of the piston being mounted fixed and coupled with the external tube in such a way that the piston rod and the external tube are interdependent when sliding relative to the body of the shock-absorbing device and allow coordination between insertion of the piston rod into the hydraulic chamber and definition of a suitable volume by the annular space between the external tube and the body of the shock-absorbing device.

5. The compensation device for a hydraulic suspension shock-absorbing device as claimed in claim 4, wherein the part of the external tube that is not opposite the body of the shock-absorbing device is formed by a cartridge defining a sealed volume in which a gas is compressed between one end of the cartridge and the surface of the body of the shock-absorbing device into which is inserted the rod of the piston including a wall that is sealed between the volume of gas and the volume of fluid by a first seal positioned between the wall and the rod and by a second seal positioned between the outline of the wall and the inner edge of the external tube, the volume of compressed gas retaining the fluid in the hydraulic part of the shock-absorbing device under pressure through the sealed wall, exerting gas pressure on the fluid in the hydraulic part with the help of seals that keep the separation tight between gas and fluid by the wall.

6. The compensation device for a hydraulic suspension shock-absorbing device as claimed in claim 2, wherein, the annular space being sealed by one or several seals positioned between the inner wall of the external tube and the outer wall of the body of the shock-absorbing device and mounted fixed on the inner wall of the external tube or the outer wall of the body of the shock-absorbing device, at least a seal being either subject to deformation or movement relative to the structure on which it is mounted fixed to compensate for variation in the volume of the annular space.

7. The compensation device for a hydraulic suspension shock-absorbing device as claimed in claim 1, wherein, the shock-absorbing device being coupled with a spring whereof a first end is supported against the part of the vehicle to which the rod of the piston is attached, the external tube that slides tightly with the cartridge of the body of the shock-absorbing device also forms a cartridge closing the hydraulic part of the shock-absorbing device being traversed by the rod of the piston, the external tube includes at least one fastening device against which the second end of the spring is supported in order to exert pressure on the external tube and to keep the fluid in the hydraulic cavity under pressure.

8. The compensation device for a hydraulic suspension shock-absorbing device as claimed in claim 7, wherein, insertion of the rod of the piston into the hydraulic chamber leads to sliding by spacing of the cartridge of the shock-absorbing device body and of the cartridge of the external tube; which increases the total volume of the hydraulic part of the shock-absorbing device; the increase in volume being proportional to the volume of the part of the rod of the piston inserted into the chamber.

9. An operating process of a compensation device for a hydraulic suspension shock-absorbing device as claimed in claim 1, comprising at least:
a step during which the shock-absorbing device is compressed and at least one part of the rod of the piston is inserted into one of the chambers of the hydraulic part of the shock-absorbing device; and
a compensation phase through:
a step during which the body of the shock-absorbing device slides relative to the external tube to adapt the annular volume to insertion of the rod of the piston into one of the hydraulic chambers.

10. The operating process, as claimed in claim 9, of a compensation device for a hydraulic suspension shock-absorbing device, wherein the process further comprises at least a phase during which the fluid in the hydraulic part of the shock-absorbing device is kept under pressure through:
a pressurization step created by compressed gas through a sealed wall separating the hydraulic part from the volume of compressed gas in the shock-absorbing device by compensation of the pressure exerted by the fluid in the hydraulic part against the sealed wall, or
a pressurization step created by a spring compressing the external tube to reduce the total volume of the hydraulic part into which the rod of the piston is partly inserted.
